(19) United States
(12) Patent Application Publication
(10) Pub. No.: US 2011/0249117 A1
(43) Pub. Date: Oct. 13, 2011

(54) IMAGING DEVICE, DISTANCE MEASURING METHOD, AND NON-TRANSITORY COMPUTER-READABLE RECORDING MEDIUM STORING A PROGRAM

(75) Inventors: Yuki YOSHIHAMA, Inagi-shi (JP); Keiichi Sakurai, Akishima-shi (JP); Mitsuyasu Nakajima, Nishitamagun-mizuhomachi (JP); Takashi Yamaya, Fussa-shi (JP)

(73) Assignee: CASIO COMPUTER CP., Tokyo (JP)

(21) Appl. No.: 13/082,638

(22) Filed: Apr. 8, 2011

(30) Foreign Application Priority Data
Apr. 8, 2010 (JP) 2010-089681
Mar. 31, 2011 (JP) 2011-080828

(51) Int. Cl. H04N 7/18

(52) U.S. Cl. 348/135; 348/E07.085

(57) ABSTRACT

The distance between two points specified on an object is measured. The imaging part acquires a pair of images having parallax in one imaging operation on one and the same object. The display part displays a display image based on at least one image of the pair of images acquired. The reception part receives a start point and an end point specified on the object in the display image. The distance acquisition part calculates the positions in a real space of the start and end points specified on the object based on one pair or multiple pairs of images and acquires the distance between the start and end points on the object based on the calculated start and end point positions in the real space.

### CROSS-REFERENCE TO RELATED APPLICATION

This application claims the benefit of Japanese Patent Application No. 2010-089681 filed Apr. 8, 2010, and Japanese Patent Application No. 2011-080828 field Mar. 31, 2011, the entire disclosure of which is incorporated by reference herein.

### FIELD

This application relates to an imaging device and measuring method for measuring the length of an object, and a non-transitory computer-readable recording medium storing a program.

### BACKGROUND

So-called stereo cameras comprising two imaging parts and capable of capturing three-dimensional images are well known. The imaging parts of such a stereo camera simultaneously capture images of an object to acquire two, right-eye and left-eye, images.

A technique for measuring the distance to an object with the simultaneous use of multiple stereo cameras is also known.

However, as a matter of fact, no useful technique has been proposed for measuring the distance between two points specified by the user on an object with accuracy by means of an imaging device such as a stereo camera.

### SUMMARY

The present invention is invented in view of the above circumstances and an exemplary object of the present invention is to provide an imaging device and measuring method for measuring the distance between two points specified on an object with accuracy and a non-transitory computer-readable recording medium storing a program for realizing them on a computer.

In order to achieve the above object, the imaging device according to a first exemplary aspect of the present invention comprises:

an imaging part capturing a pair of images having parallax in one imaging operation on one and the same object;

a display part displaying a display image based on at least one image of the pair of images;

a reception part receiving a start point and an end point specified on the object in the display image; and

a distance acquisition part calculating the positions in a real space of the start and end points specified on the object based on one pair or multiple pairs of the images, and acquiring a distance between the start and end points on the object based on the calculated start and end point positions in the real space.

In order to achieve the above object, the distance measuring method according to a second exemplary aspect of the present invention is a method of measuring the distance between two points specified on one and the same object with an imaging device having an imaging part acquiring a pair of images having parallax in one imaging operation on the object, comprising the following steps:

displaying a display image based on at least one image of the pair of images;

receiving a start point and an end point specified on the object in the display image; and

calculating the positions in a real space of the start and end points specified on the object based on one pair or multiple pairs of the images, and acquiring a distance between the start and end points on the object based on the calculated start and end point positions in the real space.

In order to achieve the above object, the non-transitory computer-readable recording medium according to a third exemplary aspect of the present invention stores a program that allows a computer controlling an imaging device having an imaging part acquiring a pair of images having parallax in one imaging operation on one and the same object to realizes the following functions:

displaying a display image based on at least one image of the pair of images;

receiving a start point and an end point specified on the object in the display image; and

calculating the positions in a real space of the start and end points specified on the object based on one pair or multiple pairs of the images, and acquiring a distance between the start and end points on the object based on the calculated start and end point positions in the real space.

### BRIEF DESCRIPTION OF THE DRAWINGS

A more complete understanding of this application can be obtained when the following detailed description is considered in conjunction with the following drawings, in which:

FIG. 1A is an illustration showing the appearance of a digital camera according to an embodiment of the present invention;

FIG. 1B is an illustration showing the principle of a parallel stereo camera according to an embodiment of the present invention;

FIG. 2 is a block diagram showing the configuration of a digital camera according to an embodiment of the present invention;

FIG. 3 is a flowchart for explaining the distance measuring procedure;

FIG. 4 is a flowchart for explaining the procedure of measurement mode 1 executed in the “distance measuring procedure” shown in FIG. 3;

FIG. 5 is a flowchart for explaining the three-dimensional model creation procedure;

FIG. 6 is a flowchart for explaining the procedure of measurement mode 2 executed in the “distance measuring procedure” shown in FIG. 3;

FIG. 7 is a flowchart for explaining the camera position estimation procedure;

FIG. 8 is a flowchart for explaining the coordinate conversion parameter acquisition procedure;

FIG. 9 is a flowchart for explaining the procedure of measurement mode 3;

FIGS. 10A and 10B are illustrations for explaining how a measuring start position and a measuring end position are specified on an object in the present invention by means of a touch panel (FIG. 10A) and by means of a cross-shaped button (FIG. 10B);

FIG. 11 is an illustration for explaining the procedure of measurement mode 3;

FIG. 12 is an illustration showing an exemplary display of measurement results;

FIG. 13 is an illustration for explaining the calculation of position information (Part 1); and

FIG. 14 is an illustration for explaining the calculation of position information (Part 2).

### DETAILED DESCRIPTION

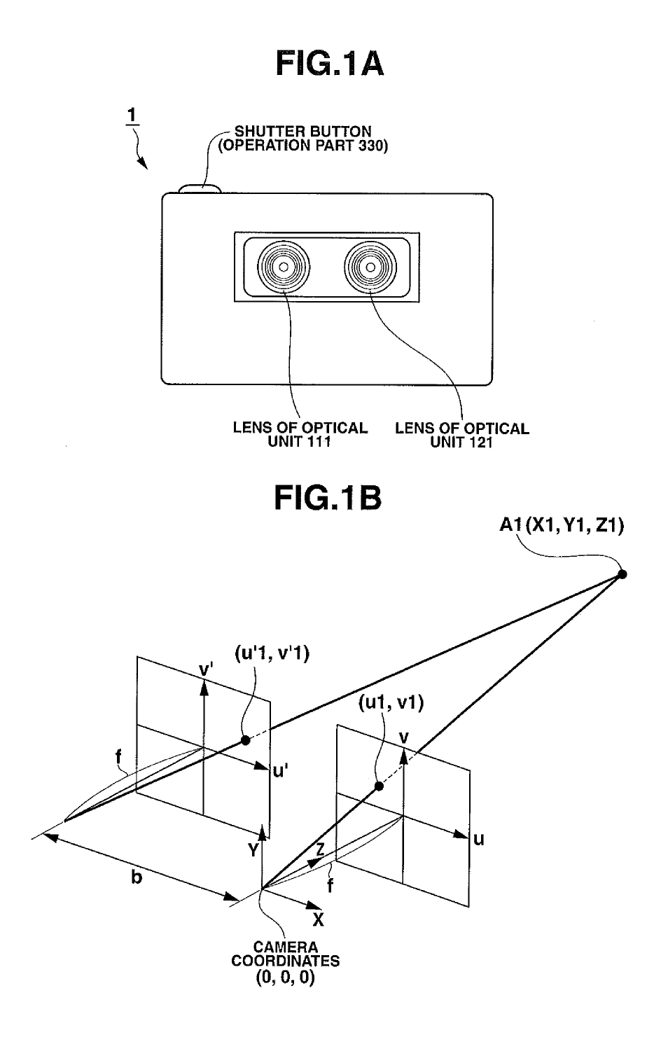

An embodiment of the present invention will be described hereafter with reference to the drawings. In this embodiment, the present invention is realized in a digital still camera (digital camera, hereafter) by way of example. A digital camera 1 according to this embodiment shown in FIG. 1A is a so-called compound eye camera (stereo camera) comprising functions an ordinary camera possesses and two sets of imaging configuration. The digital camera 1 realizes a stereo camera configuration in a so-called compact camera.

The digital camera 1 has a three-dimensional modeling (3D modeling) function using captured images. The 3D modeling function of the digital camera 1 according to this embodiment utilizes a pattern projection method for capturing images suitable for 3D modeling.

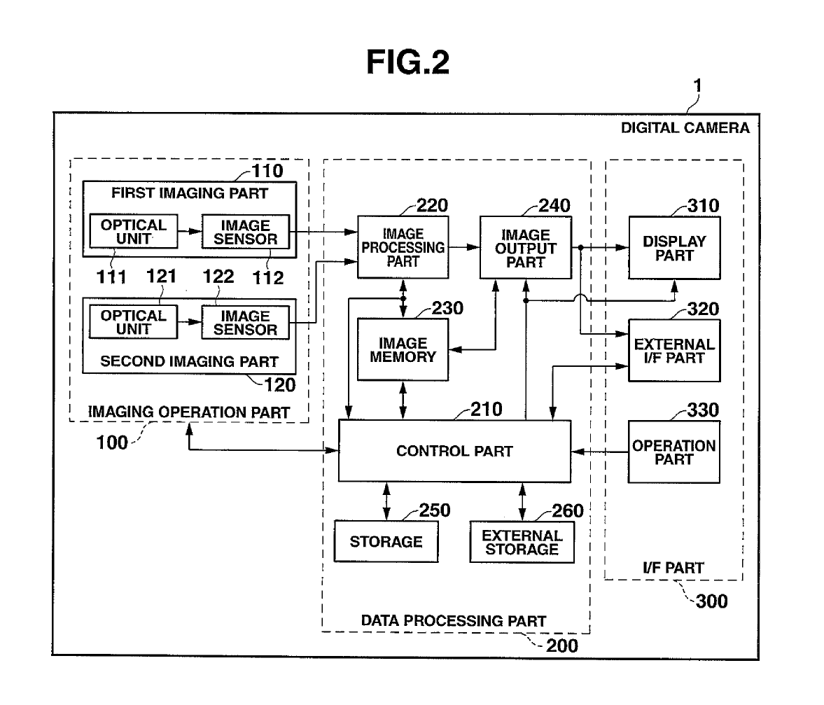

FIG. 2 is a block diagram showing the configuration of the digital camera 1. The digital camera 1 is composed of, as shown in the figure, an imaging operation part 100, a data processing part 200, and an I/F (interface) part 300.

The imaging operation part 100 performs imaging operation and is composed of, as shown in FIG. 2, a first imaging part 110 and a second imaging part 120.

As described above, the digital camera 1 is a stereo camera (compound eye camera), having the first imaging part 110 and second imaging part 120. The first and second imaging parts 110 and 120 have the same structure.

In the following explanation, the components of the first imaging part 110 will be referred to by reference numbers of 110s and the components of the second imaging part 120 will be referred to by reference numbers of 120s. The components having the same last digit are the components of a same configuration.

As shown in FIG. 2, the first imaging part 110 (second imaging part 120) is composed of an optical unit 111 (121), an image sensor 112 (122), and so on.

The optical unit 111 (121) contains, for example, a lens, an aperture mechanism, a shutter mechanism, and so on and performs optical operation regarding imaging. In other words, the optical unit 111 (121) operates to collect the incident light and adjust optical elements regarding the field angle, focus, and exposure, such as the focal length, aperture, and shutter speed.

Here, the shutter mechanism contained in the optical unit 111 (121) is a so-called mechanical shutter. However, the optical unit 111 (121) does not need to contain a shutter mechanism where the shutter operation is conducted only by the image sensor operation.

The optical unit 111 (121) operates under the control of a control part 210, which will be described later.

The image sensor 112 (122) generates electric signals according to the incident light collected by the optical unit 111 (121). The image sensor 112 (122) is composed of, for example, an image sensor such as a CCD (charge coupled device) and CMOS (complementally metal oxide semiconductor). The image sensor 112 (122) performs photoelectric conversion to generate electric signals corresponding to the received light and outputs them to the data processing part 200.

As described above, the first and second imaging parts 110 and 120 have the same structure. More specifically, they have the same specification for all of the focal length f and F value of the lens, the aperture range of the aperture mechanism, the image sensor size, as well as the number of pixels, arrangement, and area of pixels in the image sensor.

As shown in FIG. 1A, the lens of the optical unit 111 and the lens of the optical unit 121 are provided on the same face of the exterior of the digital camera 1.

More specifically, these lenses are provided with a given distance from each other in the manner that their centers are on one and the same horizontal line when the digital camera 1 is held horizontally with the shutter button facing upward. In other words, when the first and second imaging parts 110 and 120 operate at the same time, they capture two images (a pair of images) of the same object. In this case, the images are captured with the optical axes horizontally shifted from each other.

More specifically, the first and second imaging parts 110 and 120 are so provided as to yield the optical characteristics as shown in the perspective projection model in FIG. 1B. The perspective projection model in FIG. 1B is based on a three-dimensional, X, Y, and Z, orthogonal coordinate system. The coordinate system of the first imaging part 110 will be termed “the camera coordinates” hereafter. FIG. 1B shows the camera coordinates with the point of origin coinciding with the optical center of the first imaging part 110.

In the camera coordinates, the Z axis extends in the optical direction of the camera and the X and Y axes extend in the horizontal and vertical directions of an image, respectively. The intersection between the optical axis and the coordinate plane of an image is the point of origin (namely, the optical center). With the pixel pitch of the image sensor being converted to conform to the camera coordinates in unit of length, an object A1 is located at image coordinates (u1, v1) on the image coordinate plane of the first imaging part 110 and at image coordinates (u′ 1, v′ 1) on the image coordinate plane of the second imaging part 120.

The first and second imaging parts 110 and 120 are provided in the manner that their optical axes are parallel (namely, the angle of convergence is 0) and the image coordinate axis u of the first imaging part 110 and the image coordinate axis u′ of the second imaging part 120 are on the same line and in the same direction (namely, the epipolar lines are aligned). Furthermore, as described above, the first and second imaging parts 110 and 120 have the same foal length f and pixel pitch and their optical axes are orthogonal to their image coordinate planes. Such a structure is termed “parallel stereo.” The first and second imaging parts 110 and 120 of the digital camera 1 constitute a parallel stereo structure.

Returning to FIG. 2, the structure of the digital camera 1 will further be described.

The data processing part 200 processes electric signals generated through imaging operation by the first and second imaging parts 110 and 120, and creates digital data presenting captured images. Furthermore, the data processing part 200 performs image processing on the captured images. As shown in FIG. 2, the data processing part 200 is composed of a control part 210, an image processing part 220, an image memory 230, an image output part 240, a storage 250, an external storage 260, and so on.

The control part 210 is composed of, for example, a processor such as a CPU (central processing unit) and a primary storage such as a RAM (random access memory). The control part 210 executes programs stored in the storage 250, which will be described later, to control the parts of the digital camera 1. In this embodiment, the control part 210 executes given programs to realize the functions regarding the procedures described later. In this embodiment, it is the control part 210 that executes operations regarding the procedures described later. However, the operations can be executed by a dedicated processor independent from the control part 210.

The image processing part 220 is composed of, for example, an ADC (analog-digital converter), a buffer memory, a processor for image processing (a so-called image processing engine), and so on. The image processing part 220 creates digital data presenting captured images based on electric signals generated by the image sensors 112 and 122.

More specifically, the ADC converts analog electric signals from the image sensor 112 (122) to digital signals and stores them in the buffer memory in sequence. The image processing engine performs so-called development on the buffered digital data to adjust the image quality and compress the data.

The image memory 230 is composed of, for example, a storage such as a RAM and flash memory. The image memory 230 temporarily stores captured image data created by the image processing part 220 and image data to be processed by the control part 210.

The image output part 240 is composed of, for example, a RGB signal generation circuit. The image output part 240 converts image data expanded in the image memory 230 to RGB signals and outputs them on the display screen (the display part 310 that will be described later).

The storage 250 is composed of, for example, a storage such as a ROM (read only memory) and flash memory. The storage 250 stores programs and data necessary for operations of the digital camera 1. In this embodiment, the storage 250 stores operation programs to be executed by the control part 210 and parameters and calculation formulae necessary for executing the operation programs.

The external storage 260 is composed of, for example, a storage detachably mounted on the digital camera 1 such as a memory card. The external storage 260 stores image data captured by the digital camera 1.

The I/F (interface) part 300 is in charge of interface between the digital camera 1 and its user or an external device. The I/F part 300 is composed of a display part 310, an external I/F part 320, an operation part 330, and so on.

The display part 310 is composed of, for example, a liquid crystal display. The display part 310 displays various screens necessary for operating the digital camera 1, a live view image (finder image) at the time of capturing an image, captured images, and so on. In this embodiment, the display part 310 displays captured images and the like based on image signals (RGB signals) from the image output part 240.

The external I/F part 320 is composed of, for example, a USB (universal serial bus) connector, video output terminals, and so on. The external I/F part 320 is used to transfer image data to an external computer device or display captured images on an external monitor.

The operation part 330 is composed of various buttons provided on the outer surface of the digital camera 1. The operation part 330 generates input signals according to operation by the user of the digital camera 1 and supplies them to the control part 210. The buttons of the operation part 330 include a shutter button for shutter operation, a mode button for specifying an operation mode of the digital came 1, and an arrow key and function buttons for various settings.

The configuration of the digital camera 1 necessary for realizing the present invention is described above. The digital camera 1 further comprises configurations for realizing general digital camera functions.

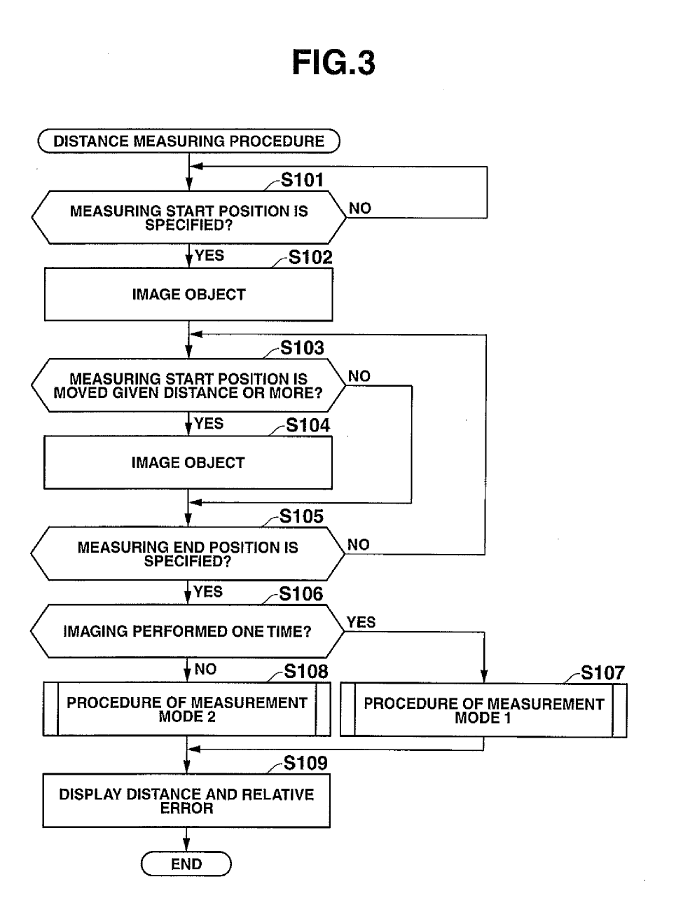

The distance measuring procedure executed by the digital camera 1 having the above configuration will be described hereafter with reference to the flowcharts in FIGS. 3 to 9.

First, the control part 210 determines whether any measuring start position is specified by the user (Step S101). If no measuring start position is specified (Step S101: NO), the control part 210 executes the procedure of Step S101 again. On the other hand, if a measuring start position is specified (Step S101: YES), the control part 210 captures images of an object (Step S102). The captured images are stored, for example, in the image memory 230.

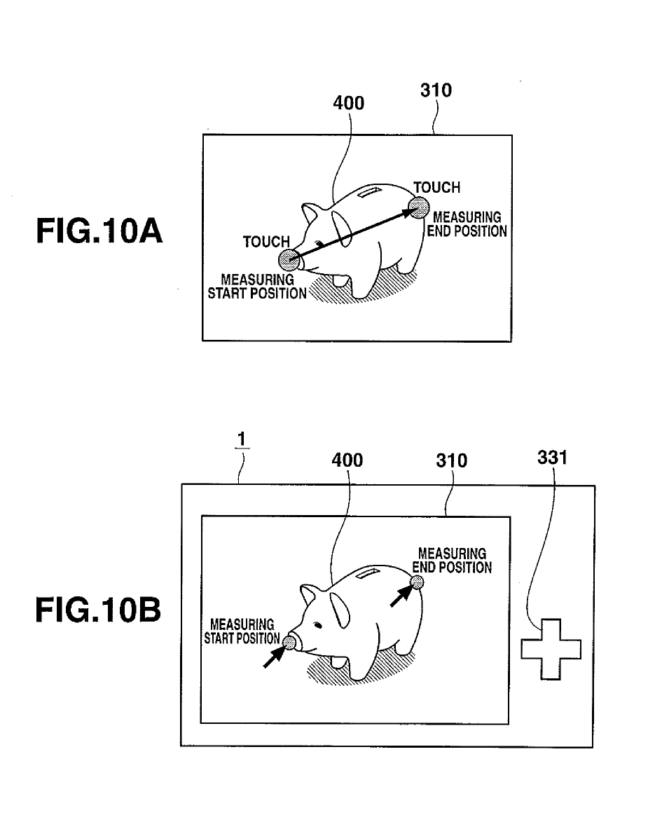

Here, how a measuring start position and a measuring end position are specified is described with reference to FIGS. 10A and 10B. FIG. 10A shows a method of specifying a measuring start position and a measuring end position on an object 400 by touching the touch panel screen of the display part 310. FIG. 10B shows a method of specifying a measuring start position and a measuring end position on the object 400 by moving a pointer on the screen by means of a cross-shaped button 331.

After capturing images, the control part 210 determines whether the measuring start position is moved a given distance or more (Step S103). For example, the control part 210 determines whether the measuring start position has moved by equal to or more than a given number of pixels from the measuring start position at the last imaging in a live view image (finder image). If the measuring start position is not included in the live view image (that is, the measuring start position is out of the frame), the control part 210 determines whether the position of the object 400 in the live view image has moved by equal to or more than a given number of pixels from the position where the object 400 was at the last imaging. If the control part 210 determines in this manner that the measuring start position is moved the given distance or more (Step S103: YES), the control part 210 captures images again (Step S104). If the measuring start position is not moved the given distance or more (Step S103: NO) or after the procedure of Step S104, the control part 210 determines whether any measuring end position is specified by the user (Step S105). If a measuring end position is specified by the user (Step S105: YES), the control part 210 executes the procedure of Step S106.

On the other hand, if no measuring end position is specified by the user (Step S105: NO), the control part 210 executes the procedure of Step S103 again.

After completing the procedure of Step S105, the control part 210 determines whether the imaging is performed one time (Step S106). If the control part 210 determines that the imaging is performed one time (Step S106: YES), the control part 210 executes the procedure of measurement mode 1 (Step S107).

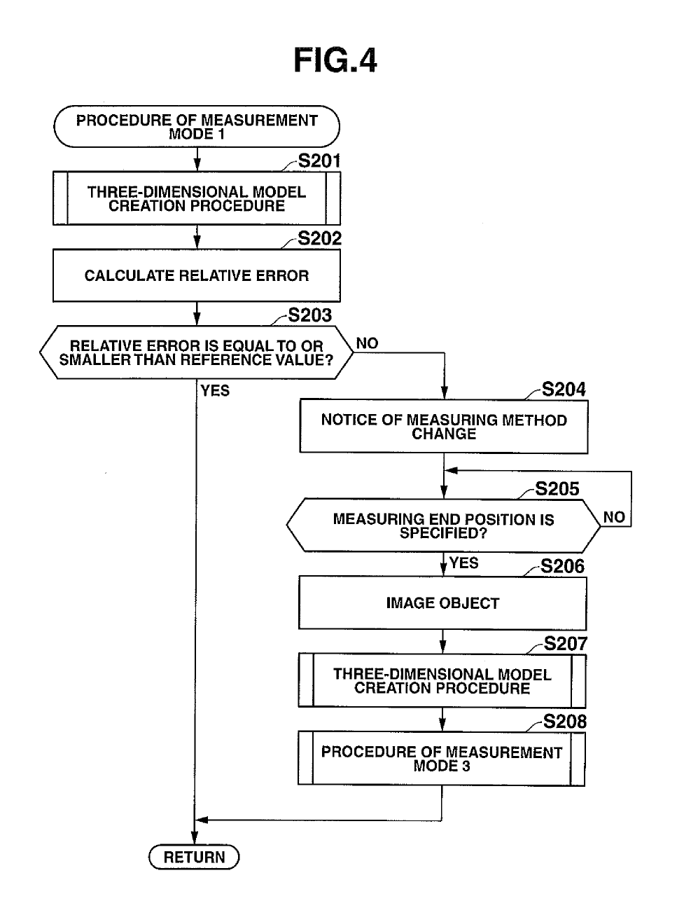

Here, the procedure of measurement mode 1 is described with reference to the flowchart shown in FIG. 4.

The digital camera 1 of this embodiment measures the distance between any two points on an object 400. In doing so, the digital camera 1 utilizes different measuring methods (measurement modes) depending on the distance to the object 400 or the size of the object 400.

The procedure of measurement mode 1 is utilized when the distance from the imaging position to the object 400 is small and the entire object 400 is included in a pair of captured images. In this procedure, the parallax of the pair of images is utilized to measure the distance.

First, the control part 210 executes a three-dimensional model creation procedure (Step S201).

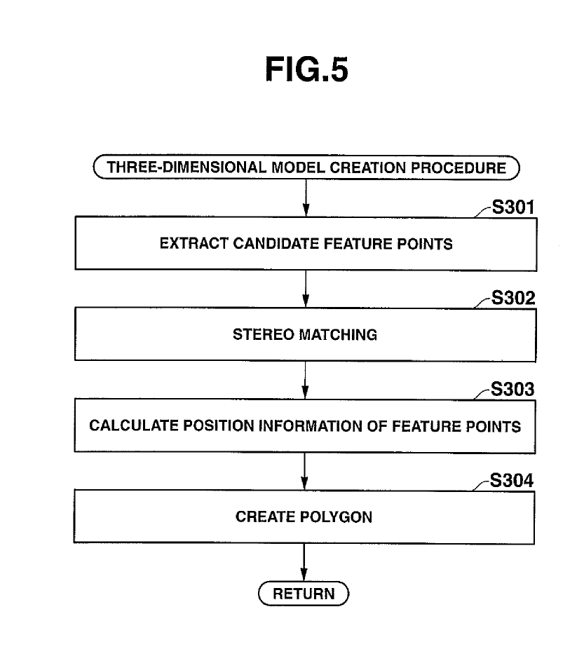

The three-dimensional model creation procedure will be described with reference to the flowchart shown in FIG. 5. The three-dimensional model creation procedure is a procedure to create a three-dimensional model based on a pair of images. In other words, the three-dimensional model creation procedure is a procedure to create a three-dimensional model seen from a single camera position.

First, the control part 210 extracts candidate feature points (Step S301). For example, the control part 210 detects corners in an image A (an image captured by the first imaging part 110). For detecting corners, points having a corner feature quantity, such as Harris, equal to or greater than a given threshold and having the largest feature quantity within a given radius are selected as corner points. Therefore, pointed ends of an object are selected as feature points exhibiting feature with respect to other points.

After completing the procedure of Step S301, the control part 210 executes stereo matching for finding the points (corresponding points) in an image B (an image captured by the second imaging part 120) corresponding to the feature points in the image A (Step S302). More specifically, the control part 210 assumes that a point having a degree of similarity equal to or greater than a given threshold and having the highest degree of similarity (having a degree of difference equal to or lower than a given threshold and having the lowest degree of difference) in template matching is the corresponding point. For template matching, various known techniques are available, including sum of absolute differences (SAD), sum of squared differences (SSD), normalized correlation (NCC or ZNCC), and direction sign correlation.

After completing the procedure of Step S302, the control part 210 calculates the position information of the feature points based on the parallax information of corresponding points found in Step S302, field angles of the first and second imaging parts 110 and 120, and a reference line length (Step S303). The created position information of feature points is stored, for example, in the storage 250.

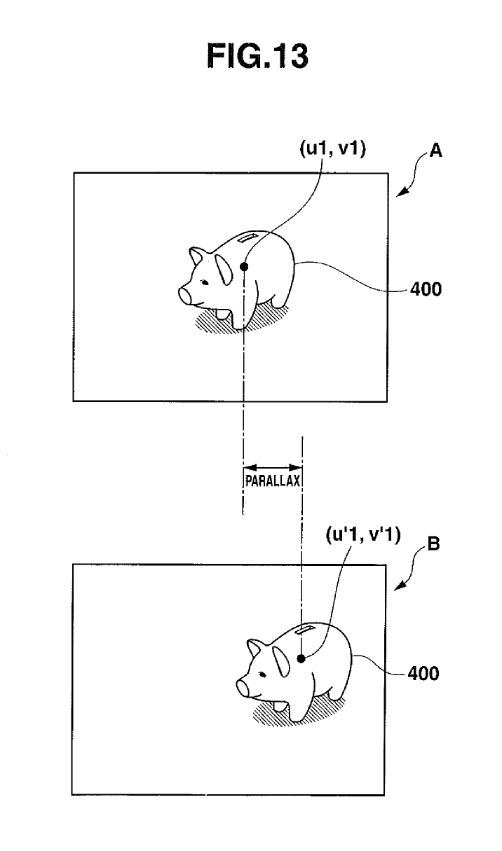

Here, the calculation of position information is described in detail. FIG. 13 shows exemplary images A and B used in template matching. In FIG. 13, as a result of template matching, a feature point (u1, v1) on an object 400 in the image A matches a position (u′ 1, v′ 1) on the object 400 in the image B. The digital camera 1 of this embodiment is a parallel stereo camera in which the optical axes of the first and second imaging parts 110 and 120 are shifted from each other in the horizontal direction; therefore, there is a parallax (u′−u) between the matched positions in the images A and B.

Here, it is assumed that the actual position corresponding to the matched (corresponding) feature points as a result of template matching is at a point A1 (X1, Y1, Z1) on the camera coordinates shown in FIG. 1B. The coordinates (X1, Y1, Z1) of the point A1 are expressed by Math 1 to Math 3, respectively. As mentioned above, (u1, v1) is the projected point on the image coordinate plane of the first imaging part 110 (namely, an object image) and (u′ 1, v′ 1) is the projected point on the image coordinate plane of the second imaging part 120 (namely, a reference image). In addition, b is the distance between the optical axes of the first and second imaging parts 110 and 120 (reference line length).

X1=(b*u1)/(u′1−u1) (Math 1)

Y1=(b*v1)/(u′1−u1) (Math 2)

Z1=(b*f)/(u′1−u1) (Math 3)

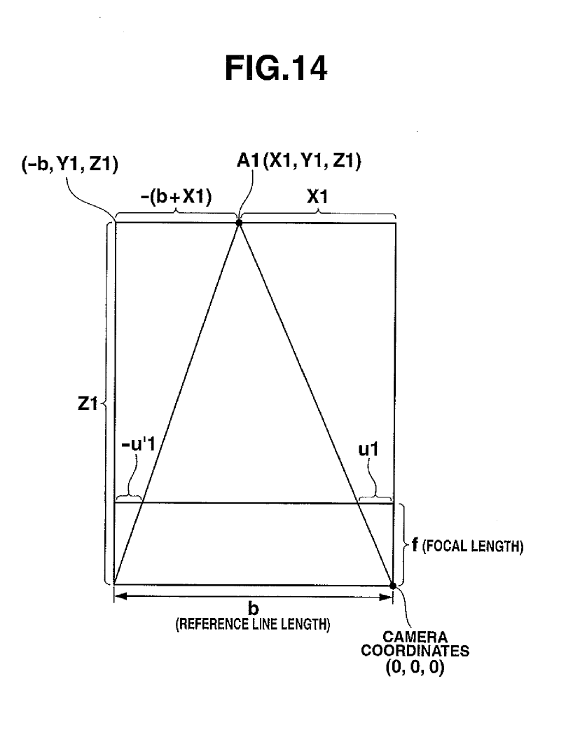

The Math 3 is derived from the principles of triangulation. The principles of triangulation will be described with reference to FIG. 14.

FIG. 14 is a schematic illustration showing the camera coordinates of the parallel stereo configuration shown in FIG. 1B when seen from above. Since the camera coordinates are defined from the point of view of the first imaging part 110, X1 in the camera coordinates is assigned to the coordinate of the subject position A1 in the X axis direction, and its value can be computed using the formula (1) given below:

X1=(u1*Z1)/f (1)

Meanwhile, the coordinate of A1 in the X axis direction from the point of view of the second imaging part 120 is the sum of the reference line length b and X1 in the camera coordinates, which can be computed using the formula (2) given below:

b+X1=(u′1*Z1)/f (2)

From these formulae (1) and (2), the above Math 3 is derived.

After completing the procedure of Step S303, the control part 210 performs Delaunay division based on the position information of the feature points calculated in Step S303 to create a polygon (Step S304). The created polygon information is stored, for example, in the storage 250. After completing the procedure of Step S304, the control part 210 ends the three-dimensional model creation procedure.

When only a small number of feature points are obtained, deficient of object shape information may lead to failure of acquisition of an accurate three-dimensional model of the object. On the other hand, when loose conditions are used for extracting candidate feature points or for stereo matching so as to obtain more feature points, the following inconvenience may occur; candidate feature points may include inappropriate points or the stereo matching may yield erroneous correspondence. Then, the accuracy of position, namely the accuracy of modeling will deteriorate. For this reason, a proper number of feature points should be extracted for preventing deterioration in the accuracy of modeling and obtaining an accurate three-dimensional model of the object.

Returning to the flowchart in FIG. 4, the control part 210 calculates a relative error (Step S202).

Here, the relative error is explained.

The relative error is obtained using the following formula:

ΔZ/Z=(p/B)·(Z/f)

in which Z is the distance to the object 400, ΔZ is the accuracy of depth, ΔZ/Z is the relative error, B is the parallel shift distance, f is the focal length, and p is the pixel size of the image sensor. Then, (p/B) presents the accuracy. The relative error ΔZ/Z is obtained by multiplying (p/B) by a magnification (Z/f).

If the relative error is equal to or smaller than a reference value (Step S203: YES), the control part 210 ends the procedure of the measurement mode 1. Returning to the flowchart in FIG. 3, the control part 210 displays the distance and relative error obtained based on the coordinates of the measuring start and end positions on the three-dimensional model and ends the procedure (Step S109).

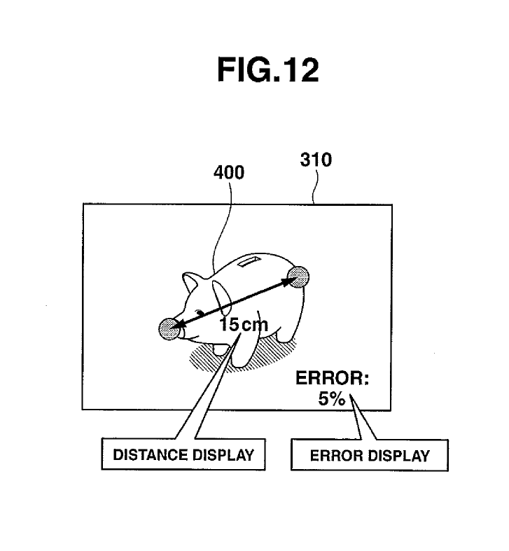

In Step S109, for example, as shown in FIG. 12, when the relative error is equal to or smaller than 20%, the measured distance and relative error are displayed on the screen.

Depending on the value of the relative error, a message such as “the accuracy may be increased by capturing a closer image” may be presented to the user.

On the other hand, if the relative error exceeds the reference value (Step S203: NO), the control part 210 conducts measurement with a different measuring method. To do so, the control part 210 informs the user accordingly and urges him/her to capture an image of the object again after changing the camera position (Step S204).

After a measuring end position is specified by the user (Step S205: YES), the control part 210 captures images of the object (Step S206).

Then, the control part 210 executes the three-dimensional model creation procedure (Step S207). Subsequently, the control part 210 executes the procedure of measurement mode 3 (Step S208) and ends the procedure of the measurement mode 1.

The procedure of measurement mode 3 will be described in detail later.

Returning to the flowchart in FIG. 3, if the imaging is performed multiple times (Step S106: NO), the control part 210 executes the procedure of measurement mode 2 (Step S108).

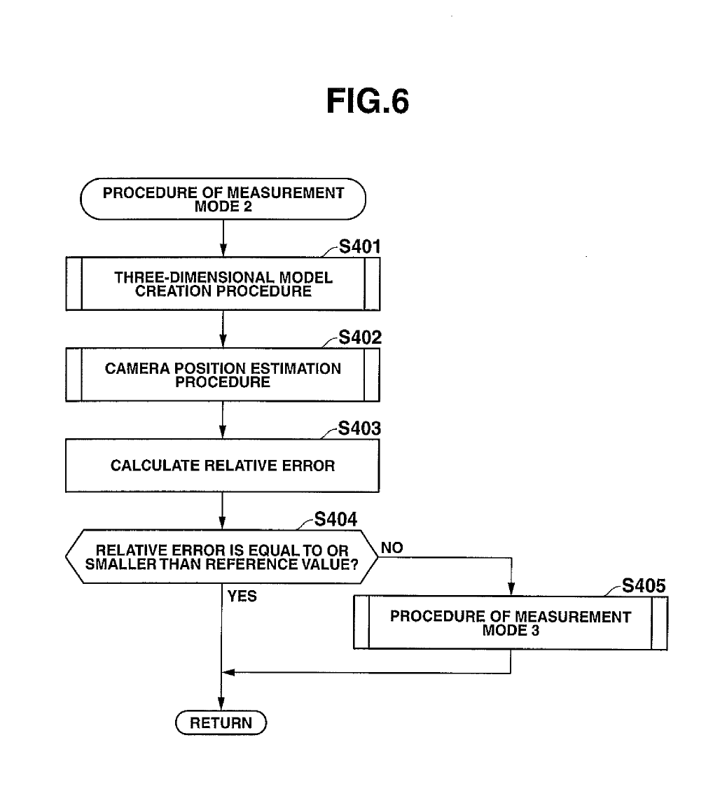

Here, the procedure of measurement mode 2 is described with reference to the flowchart in FIG. 6.

The procedure of measurement mode 2 is executed when the distance from the imaging position to the object 400 is small and the object 400 is too large for the measuring start and end positions to be included in a pair of images.

For example, when a measuring start position on the object 400 is captured in the first imaging operation and a measuring end position is captured in the second imaging operation after the camera position is changed, at least three feature points common to the two pairs of captured images are detected. Based on those feature points, the relative position with respect to the first camera position is acquired, from which the coordinates of the measuring start and end positions are obtained and the distance is measured in accordance with the principles of triangulation. If two pairs of images are not enough to include a start point (measuring start position) and an end point (measuring end position), multiple pairs of images are captured while tracing from the start point to the end point. Then, the distance between the start and end points is measured as described above.

Here, a method of calculating the camera position from two pairs of captured images is discussed.

First, the control part 210 executes the three-dimensional model creation procedure (Step S401).

After completing the procedure of Step S401, the control part 210 executes a camera position estimation procedure (Step S402).

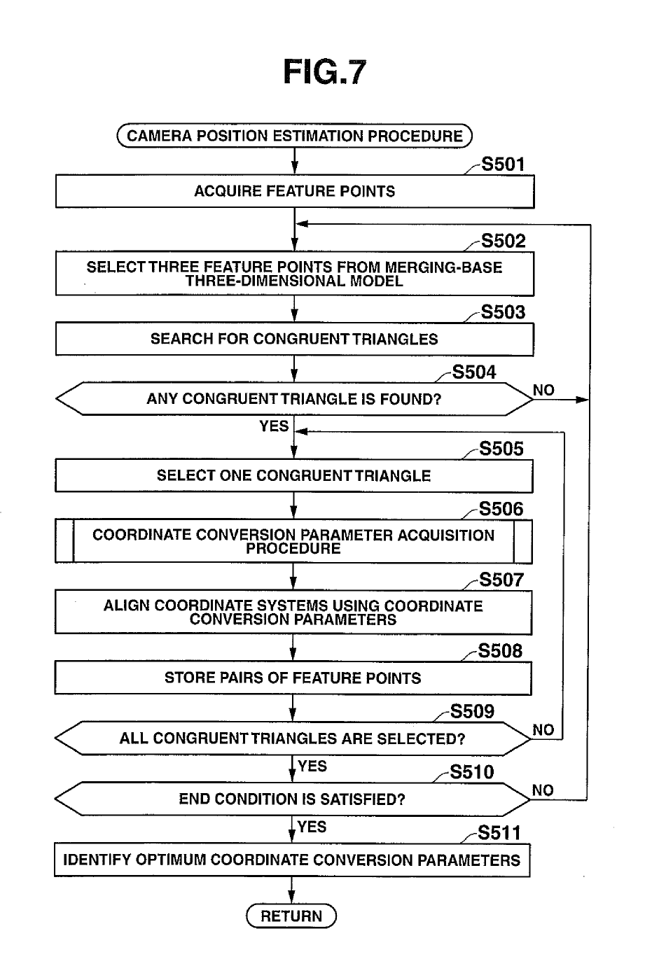

Here, the camera position estimation procedure is described with reference to the flowchart in FIG. 7.

First, the control part 210 obtains feature points in a three-dimensional space from a merging-base three-dimensional model and merging three-dimensional models (Step S501). For example, the control part 210 selects feature points having a high degree of corner strength and a high degree of correspondence in stereo matching among the feature points of a merging-base three-dimensional model (or a merging three-dimensional model). Alternatively, the control part 210 can execute matching with SURF (speeded-up robust features) feature quantity in consideration of epipolar line restriction on a pair of images to obtain feature points. Here, a merging-base three-dimensional model is a three-dimensional model obtained in the first imaging operation and used as the base for merging. On the other hand, a merging three-dimensional model is a three-dimensional model obtained in the second or subsequent imaging operation and merged into the merging-base three-dimensional model.

After completing the procedure of Step S501, the control part 210 selects three feature points from the merging-base three-dimensional model (Step S502). Here, the selected three feature points satisfy the following conditions (A) and (B). The condition A is that the area of a triangle having vertexes at the three feature points is not excessively small, in other words the area is equal to or larger than a predetermined area. The condition B is that a triangle having vertexes at the three feature points does not have any particularly sharp angle, in other words the angles are equal to or larger than a predetermined angle. For example, the control part 210 randomly selects three feature points until three feature points satisfying the conditions (A) and (b) are found.

After completing the procedure of Step S502, the control part 210 searches for triangles congruent to a triangle having vertexes at the three feature points selected in Step S502 among triangles having vertexes at any three feature points of a merging three-dimensional model (Step S503). For example, the triangles having three congruent sides are considered to be congruent. The procedure of Step S503 is considered to be a procedure to search for three feature points corresponding to the three feature points selected from a merging-base three-dimensional model in Step S502 among the feature points of a merging three-dimensional model. Here, the control part 210 may accelerate the search by narrowing the triangle candidates based on color information of the feature points and surrounding area or SURF feature quantity. Information presenting found triangles (typically, information presenting the coordinates in a three-dimensional space of the three feature points constituting the vertexes of the triangle) is stored, for example, in the storage 250. When there are more than one congruent triangle, information presenting all triangles is stored in the storage 250.

After completing the procedure of Step S503, the control part 210 determines whether at least one congruent triangle is found in Step S503 (Step S504). Here, it can be assumed that no congruent triangle is found when too many congruent triangles are found.

If at least one congruent triangle is found (Step S504: YES), the control part 210 selects one congruent triangle (Step S505). On the other hand, if no congruent triangle is found (Step S504: No), the control part 210 returns to the procedure of Step S502.

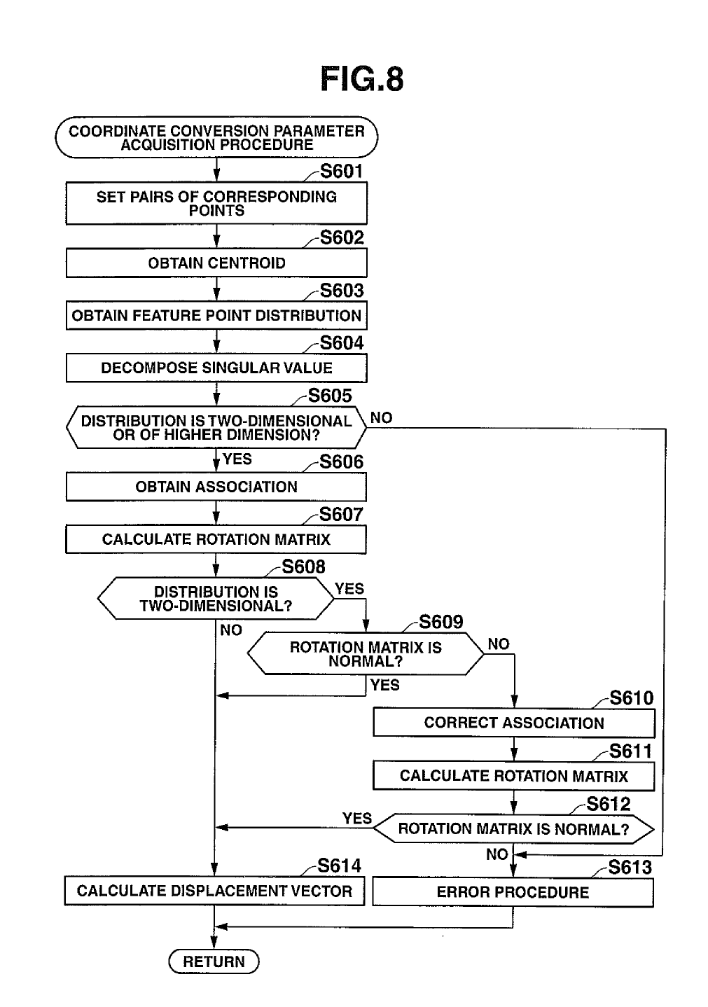

After completing the procedure of Step S505, the control part 210 executes a coordinate conversion parameter acquisition procedure (Step S506). The coordinate conversion parameter acquisition procedure will be described in detail with reference to the flowchart in FIG. 8. The coordinate conversion parameter acquisition procedure is a procedure to acquire coordinate conversion parameters for converting the coordinates of a merging three-dimensional model to the coordinates of a merging-base three-dimensional model. The coordinate conversion parameter acquisition procedure is executed on each combination of the three feature points selected in Step S502 and the congruent triangles selected in Step S505. Here, the coordinate conversion parameter acquisition procedure is a procedure to obtain a rotation matrix R and a displacement vector t satisfying Math 6 for a pair of corresponding points (a pair of feature points, a pair of vertexes) given by Math 4 and Math 5 below. The coordinates of points p and p′ given by Math 4 and Math 5 locate on a three-dimensional space viewed from each camera position. N indicates the number of pairs of the corresponding points.

$$\begin{matrix}{p}_{i} = [ \begin{matrix}{x}_{i} \\ {y}_{i} \\ {z}_{i}\end{matrix} ] ( i = 1 , 2 , … , N ) & ( Math 4 ) \\ {p}_{i}^{′} = [ \begin{matrix}{x}_{i}^{′} \\ {y}_{i}^{′} \\ {z}_{i}^{′}\end{matrix} ] ( i = 1 , 2 , … , N ) & ( Math 5 ) \\ {p}_{i} = {Rp}_{i}^{′} + t & ( Math 6 )\end{matrix}$$

First, the control part 210 defines a pair of corresponding points as shown by Math 7 and Math 8 below (Step S601). Here, c1 and c2 are matrixes of which the corresponding column vectors present the coordinates of corresponding points. It is difficult to directly obtain a rotating matrix R and a displacement vector t from this matrix. However, since the distributions of p and p′ are nearly equal, rotation after aligning the centroids of corresponding points leads to the corresponding points being superimposed. Using this technique, a rotating matrix R and a displacement vector t are obtained.

c1=[p₁p₂ . . . p_{N}] (Math 7)

c2=[p′₁p′₂ . . . p′_{N}] (Math 8)

In other words, the control part 210 obtains the centroids t1 and t2 of feature points using Math 9 and Math 10 below (Step S602).

$$\begin{matrix}t 1 = \frac{1}{N} {\sum }_{i = 1}^{N} {p}_{i} & ( Math 9 ) \\ t 2 = \frac{1}{N} {\sum }_{i = 1}^{N} {p}_{i}^{′} & ( Math 10 )\end{matrix}$$

Then, the control part 210 obtains the distributions d1 and d2 of feature points using Math 11 and Math 12 below (Step S603). Here, as described above, the distributions d1 and d2 have a relationship presented by Math 13 below.

d1=[(p₁−t1)(p₂−t1) . . . (p_{N}−t1)] (Math 11)

d2=[(p′₁−t2)(p′₂−t2) . . . (p′_{N}−t1)] (Math 12)

d1=Rd2 (Math 13)

Then, the control part 210 executes singular value decomposition of the distributions d1 and d2 using Math 14 and Math 15 below (Step S604). The singular values are arranged in descending order. Here, the symbol “*” presents complex conjugate transposition.

d1=U₁S₁V₁* (Math 14)

d2=U₂S₂V₂* (Math 15)

Then, the control part 210 determines whether the distributions d1 and d2 are two-dimensional or of a higher dimension (Step S605). The singular values correspond to the degree of extension of the distribution. Therefore, the ratios of the greatest singular value to the other singular values and the greatness of singular values are used for the determination. For example, when the second greatest singular value is equal to or greater than a given value and its ratio to the greatest singular value is within a given range, the distribution is assumed to be two-dimensional or of a higher dimension.

If the distributions d1 and d2 are not two-dimensional or of a higher dimension (Step S605: NO), a rotation matrix R cannot be obtained. Therefore, the control part 210 executes an error procedure (Step S613) and ends the coordinate conversion parameter acquisition procedure.

On the other hand, if the distributions d1 and d2 are two-dimensional or of a higher dimension (Step S605: YES), the control part 210 obtains an association K (Step S606). From Math 13 to Math 15, the rotation matrix R can be expressed by Math 16 below. Here, provided that the association K is defined by Math 17, the rotation matrix R is expressed by Math 18.

R=U₁S₁V₁*V₂S₂⁻¹U₂* (Math 16)

K=S₁V₁*V₂S₂⁻¹ (Math 17)

R=U₁KU₂* (Math 18)

Here, the characteristic vectors U correspond to the characteristic vectors of the distributions d1 and d2 and are associated by the association K. The association K has an element of 1 or −1 where the characteristic vectors correspond to each other and otherwise 0. By the way, since the distributions d1 and d2 are equal, the singular values are equal. In other words, S is also equal. The distributions d1 and d2 practically include errors and the errors are rounded. Taking these things into account, the association K ixs expressed by Math 19 below. In other words, the control part 210 calculates Math 19 in Step S606.

K=round((rows 1 to 3 of V*₁)(rows 1 to 3 of V₂)) (Math 19)

After completing the procedure of Step S606, the control part 210 calculates the rotation matrix R (Step S607). More specifically, the control part 210 calculates the rotation matrix R based on Math 18 and Math 19. Information presenting the rotation matrix R obtained by the calculation is stored, for example, in the storage 250.

After completing the procedure of Step S607, the control part 210 determines whether the distributions d1 and d2 are two-dimensional (Step S608). For example, if the least singular value is equal to or lower than a given value or its ratio to the greatest singular value is outside a given range, the distributions d1 and d2 are assumed to be two-dimensional.

If the distributions d1 and d2 are not two-dimensional (Step S608: NO), the control part 210 calculates the displacement vector t (Step S614). Here, if the distributions d1 and d2 are not two-dimensional, they are three-dimensional. Here, p and p′ satisfy a relationship presented by Math 20 below. Math 20 is transformed to Math 21. From the correspondence between Math 21 and Math 6, the displacement vector t is presented by Math 22 below.

(pᵢ−t1)=R(p′ᵢ−t2) (Math 20)

pᵢ=Rp′ᵢ+(t1−Rt2) (Math 21)

t=t1−Rt2 (Math 22)

On the other hand, if the distributions d1 and d2 are two-dimensional (Step S608: YES), the control part 210 verifies the rotation matrix R and determines whether the rotation matrix R is normal (Step S609). When a distribution is two-dimensional, one of the singular values is 0 and the association is indefinite as known from Math 17. In other words, the element at the row 3 and column 3 of K is 1 or −1; however, there is no guarantee that a correct sign is assigned in Math 19. Then, the rotation matrix R must be verified. The verification consists of confirmation of relation of outer products of the rotation matrix R or recalculation using Math 13. Here, confirmation of relation of outer products means confirmation of the column vectors (and row vectors) of the rotation matrix R satisfying restrictions imposed by the coordinate system. In a right-handed coordinate system, the outer product of the first and second column vectors is equal to the third column vector.

If the rotation matrix R is normal (Step S609: YES), the control part 210 calculates the displacement vector t (Step S614) and ends the coordinate conversion parameter acquisition procedure.

On the other hand, if the rotation matrix R is not normal (Step S609: NO), the control part 210 corrects the association K (Step S610). Here, the sign of the element at the row 3 and column 3 of the association K is inverted.

After completing the procedure of Step S610, the control part 210 calculates the rotation matrix R using the corrected association K (Step S611).

After completing the procedure of Step S611, the control part 210 determines again whether the rotation matrix R is normal to be sure (Step S612).

If the rotation matrix R is normal (Step S612: YES), the control part 210 calculates the displacement vector t (Step S614) and ends the coordinate conversion parameter acquisition procedure.

On the other hand, if the rotation matrix R is not normal (Step S612: NO), the control part 210 executes an error procedure (Step S613) and ends the coordinate conversion parameter acquisition procedure.

Returning to the flowchart in FIG. 7, the control part 210 ends the coordinate conversion parameter acquisition procedure (Step S506) and aligns the coordinate systems using the acquired coordinate conversion parameters (Step S507). More specifically, the coordinates of the feature points of the merging three-dimensional model are converted to the coordinates on the coordinate system of the merging-base three-dimensional model using Math 6.

Then, after completing the procedure of Step S507, the control part 210 stores the pairs of feature points (Step S508). Here, a pair of feature points consists of a feature point of a merging-base three-dimensional model and a feature point of which the distance from the feature point of the merging-base three-dimensional model is equal to or smaller than a given value and the smallest among the feature points of a merging three-dimensional model after the coordinate conversion. Here, the selection of three feature points in Step S502 and the selection of a congruent triangle in Step 505 are assumed to be proper as the number of pairs is larger. The pairs of feature points are stored in the storage 250 along with coordinate conversion parameter acquisition conditions (selection of three feature points in Step S502 and selection of a congruent triangle in Step 505).

After completing the procedure of Step S508, the control part 210 determines whether all congruent triangles found in Step 503 are selected in Step S505 (Step S509).

If all the congruent triangles are not selected (Step S509: NO), the control part 210 returns to the procedure of Step S505.

On the other hand, if all congruent triangles are selected (Step S509: YES), the control part 210 determines whether an end condition is satisfied (Step S510). The end condition of this embodiment consists of whether coordinate conversion parameters are acquired for a given number or more of conditions.

If the end condition is not satisfied (Step S510: NO), the control part 210 returns to the procedure of Step S502.

On the other hand, if the end condition is satisfied (Step S510: YES), the control part 210 identifies an optimum coordinate conversion parameter (Step S511). More specifically, the coordinate conversion parameter for which a largest number of pairs of feature points are obtained is identified. In other words, the one for which the selection of three feature points in Step S502 and the selection of a congruent triangle in Step S505 are optimum is identified. Here, the coordinate conversion parameter includes the rotation matrix R and displacement vector t.

After completing the procedure of Step S511, the control part 210 ends the camera position estimation procedure.

Returning to the flowchart in FIG. 6, the control part 210 calculates the relative error (Step S403). If the relative error is equal to or smaller than a reference value (Step S404: YES), the control part 210 ends the procedure of measurement mode 2. Then, returning to the flowchart in FIG. 3, the control part 210 displays the distance and relative error obtained based on the coordinates of the measuring start and end positions on the three-dimensional model and ends the distance measuring procedure (Step S109).

On the other hand, if the relative error exceeds the reference value (Step S404: NO), the control part 210 executes the procedure of measurement mode 3 (Step S405) and ends the procedure of measurement mode 2.

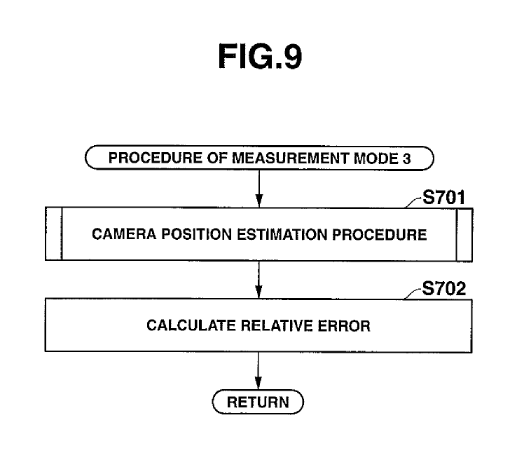

The procedure of measurement mode 3 will be described hereafter with reference to the flowchart in FIG. 9.

The procedure of measurement mode 3 is conducted when the distance from the imaging position to the object 400 is large.

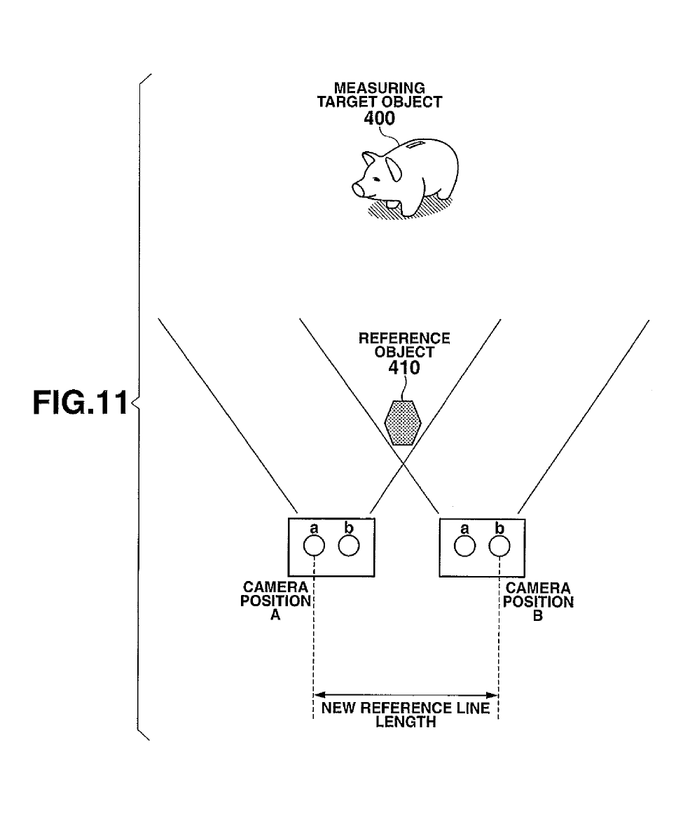

In the procedure of measurement mode 3, the control part 210 obtains the camera position using an object (a reference object 410) closer to the digital camera 1 than the measuring target object 400. Based on the results, the control part 210 measures the distance specified on the measuring target object 400 (see FIG. 11).

First, the control part 210 executes the above-described camera position estimation procedure based on the reference object 410 (Step S701).

Explanation will be made with reference to FIG. 11. The control part 210 identifies as a reference object 410 an object that is close to the digital camera 1 enough to be within the field angle ranges of the two lenses of the digital camera 1 at an original camera position A and a shifted camera position B. Then, the control part 210 obtains at least three common feature points on the reference object 410 in two pairs of captured images. Then, the relative positional relationship between the camera positions A and B can be obtained. In other words, the positional relationship between the principal points of the lens a at the camera position A and the lens b at the camera position B is obtained. Then, camera projection parameters are created based on the positional relationship between the lens principal points, namely motion parameters (consisting of the rotation matrix and translation vector) from the lens a at the camera position A.

The camera projection parameter P of the image A and the camera projection parameter P′ of the image B are obtained by Math 23 below. Then, for example, three-dimensional information (X1, Y1, Z1) is obtained by Math 24 and Math 25 using the method of least squares.

P=A·[R|t] (Math 23)

trans(u1,v1,1)˜P·trans(X1,Y1,Z1,1) (Math 24)

trans(u′1,v′1,1)˜P′·trans(X1,Y1,Z1,1) (Math 25)

In Math 24 and Math 25, the image coordinates and world coordinates are coordinates of the same order. The symbol “˜” indicates that both sides are equal except that one is an integral multiple of the other.

Then, the coordinates of the measuring start position (start point) and measuring end position (end point) are obtained and the distance specified on the measuring target object 400 is obtained.

When two times of imaging are not enough to include the start and end points, multiple pairs of images are captured while tracing from the start point to the end point. Then, the distance between the start and end points is measured as described above.

After completing the camera position estimation procedure, the control part 210 calculates the relative error at the time (Step S702) and ends the procedure of measurement mode 3.

After completing the procedure of measurement mode 3, returning to the flowchart in FIG. 3, the control part 210 displays the distance and relative error obtained based on the coordinates of the measuring start and end positions on the three-dimensional model (Step S109) and ends the distance measuring procedure.

### Modified Embodiment

The present invention is not confined to what is disclosed in the above embodiment.

In the above embodiment, the control part 210 transfers to the measurement mode 3 when the relative error exceeds a reference value. However, instead of immediately transferring the mode, the control part 210 may display a message urging the user to shorten the distance between the object 400 and imaging position via the display part 310. In other words, if the user approaches the object 400, the distance between the digital camera 1 and object 400 is reduced, whereby the accuracy of measurement will be increased. Then, if the relative error exceeds a reference value after a given period of time has elapsed since the display of message, the control part 210 executes the procedure of measurement mode 3.

As described above, the digital camera 1 according to the above embodiment of the present invention is capable of measuring the distance between two points (start point and end point) specified by the user based on the coordinate positions obtained by 3D modeling.

In doing so, the digital camera 1 selects one of the three measurement modes as appropriate to execute the distance measuring procedure. For example, when the distance from the digital camera 1 to a measuring target object is small and the start and end points are included in a pair of images simultaneously captured by the first and second imaging parts 110 and 120, the measurement mode 1 is selected. In the measurement mode 1, the distance between the two points is obtained by 3D modeling of the object based on the results of one imaging operation.

On the other hand, when the distance from the digital camera 1 to a measuring target object is small but the object is large and the start and end points are not included in a pair of images simultaneously captured, the measurement mode 2 is selected. In the measurement mode 2, the distance between the two points is obtained by 3D modeling of the object based on the results of multiple imaging operations at multiple camera positions.

Furthermore, when the distance from the digital camera 1 to a measuring target object is large and the relative error between the distance to the object and the accuracy of depth is larger than a given value although the start and end points are included in a pair of images simultaneously captured, the measurement mode 3 is selected. In the measurement mode 3, the camera position (displacement vector, rotation vector) is calculated based on an image part of another object closer than the measuring target object from the results of multiple imaging operations at multiple camera positions. Then, even if the distance from the digital camera 1 to a measuring target object is large, the distance between the two points can be calculated with accuracy.

The start and end points specified by the user on an object are displayed on the display image in a superimposed manner. The user can easily recognize the start and end points on the object.

The imaging device according to the present invention can also be realized using an existing stereo camera. More specifically, programs as executed by the above-described control part 210 are applied to an existing stereo camera. The CPU (computer) of the stereo camera executes the programs to allow the stereo camera to function as the imaging device according to the present invention.

Such programs can be distributed by any method. For example, they can be stored in a non-transitory computer-readable recording medium such as a flexible disk, CD-ROM (compact disk read-only memory), DVD (digital versatile disk), MO (magneto optical disk), and memory card for distribution. Alternatively, the programs are stored in a disk device of a server unit on a communication network. The programs are superimposed on carrier waves for distribution from the server unit via the communication network.

In such a case, if the above-described functions according to the present invention are realized by apportionment between an OS (operation system) and application programs or cooperation of an OS (operation system) and application programs, only the application programs may be stored in a recording medium.

Having described and illustrated the principles of this application by reference to one (or more) preferred embodiment(s), it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What is claimed is:

1. An imaging device, comprising:
an imaging part capturing a pair of images having parallax in one imaging operation on one and the same object;
a display part displaying a display image based on at least one image of the pair of images;
a reception part receiving a start point and an end point specified on the object in the display image; and
a distance acquisition part calculating the positions in a real space of the start and end points specified on the object based on one pair or multiple pairs of the images, and acquiring a distance between the start and end points on the object based on the calculated start and end point positions in the real space.

2. The imaging device according to claim 1, wherein when the start and end points specified on the object are included in a pair of the images, the distance acquisition part calculates the positions in a real space of the start and end points specified on the object based on the pair of images.

3. The imaging device according to claim 1, wherein when the start and end points specified on the object are not included in a pair of the images, the distance acquisition part calculates the relative coordinates of the position where a pair of images including the end point is captured with respect to the position where a pair of images including the start point is captured based on image parts of the object in multiple pairs of the images captured by the imaging part in multiple imaging operations, and calculating the positions in a real space of the start and end points specified on the object based on the calculated relative coordinates.

4. The imaging device according to claim 1, wherein the distance acquisition part calculates a relative error between a distance to the object and a accuracy of depth and, when the calculated relative error is larger than a given value, calculates the relative coordinates of the position where a pair of images including the end point is captured with respect to the position where a pair of images including the start point is captured based on image parts of another object closer to the object in multiple pairs of the images captured by the imaging part in multiple imaging operations, and calculating the positions in a real space of the start and end points specified on the object based on the calculated relative coordinates.

5. The imaging device according to claim 4, wherein the relative error (ΔZ/Z) is given by (p/B)·(Z/f) in which Z is the distance to the object, ΔZ is the accuracy of depth, B is the parallel shift distance, f is the focal length, and p is the pixel size of the imaging element.

6. The imaging device according to claim 1, wherein the display part displays the start and end points on an object that are received by the reception part on the display image in a superimposed manner.

7. A method of measuring the distance between two points specified on one and the same object with an imaging device having an imaging part acquiring a pair of images having parallax in one imaging operation on the object, comprising the following steps:
displaying a display image based on at least one image of the pair of images;
receiving a start point and an end point specified on the object in the display image; and
calculating the positions in a real space of the start and end points specified on the object based on one pair or multiple pairs of the images, and acquiring a distance between the start and end points on the object based on the calculated start and end point positions in the real space.

8. A non-transitory computer-readable recording medium storing a program that allows a computer controlling an imaging device having an imaging part acquiring a pair of images having parallax in one imaging operation on one and the same object to realizes the following functions:
displaying a display image based on at least one image of the pair of images;
receiving a start point and an end point specified on the object in the display image; and
calculating the positions in a real space of the start and end points specified on the object based on one pair or multiple pairs of the images, and acquiring a distance between the start and end points on the object based on the calculated start and end point positions in the real space.
